(19) United States
(12) Patent Application Publication
(10) Pub. No.: US 2008/0180452 A1
(43) Pub. Date: Jul. 31, 2008

(54) DISPLAY DEVICE AND DRIVING METHOD THEREOF

(75) Inventors: Kon-Ho LEE, Seongnam-si (KR); Jong-Seok CHAE, Seoul (KR); Bum-Joon KIM, Seoul (KR); Kil-Soo CHOI, Suwon-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/943,623

(22) Filed: Nov. 21, 2007

(30) Foreign Application Priority Data
Jan. 25, 2007 (KR) 10-2007-0007842

(51) Int. Cl. G06F 3/038; G09G 5/39

(52) U.S. Cl. 345/531; 345/211

(57) ABSTRACT

A display device includes a display panel having a resolution of a regular square and a plurality of pixels, a signal processor which stores first image signals corresponding to a first image of one frame and outputs second image signals corresponding to a second image having a display type changed with respect to the first image, and a data driver which converts the second image signals to data voltages to supply to the plurality of pixels.

This application claims priority to Korean Patent Application No. 10-2007-0007842, filed on Jan. 25, 2007, and all the benefits accruing therefrom under 35 U.S.C. §119, the contents of which in its entirety are herein incorporated by reference.

### BACKGROUND OF THE INVENTION

(a) Field of the Invention

The present invention relates to a display device and a driving method thereof, and more particularly, to a display device capable of providing a desired display type and a driving method thereof.

(b) Description of the Related Art

Recent trends towards lightweight and thin personal computers and televisions sets also require lightweight and thin display devices, and flat panel displays satisfying such requirements are being substituted for conventional cathode ray tubes (“CRTs”).

Such flat display panel display devices include a liquid crystal display (“LCD”), a field emission display (“FED”), an organic light emitting diode (“OLED”) display, a plasma display panel (“PDP”), etc. In general, an active matrix type of the flat panel display devices includes a plurality pixels arranged in a matrix, and controls light intensity for each pixel in accordance with given image information to display images.

In the flat panel displays, a display type of an image may be changed. In this case, the flat panel displays receive image information corresponding to a desired display type from an external device.

Meanwhile, a demand of the flat panel displays is to have a resolution of a regular square in which a resolution of the horizontal axis is the same as a resolution of the vertical axis. However, even if the flat panel displays have the resolution of the regular square, the flat panel displays would have to receive new image information corresponding to each desired display type.

### BRIEF SUMMARY OF THE INVENTION

According to exemplary embodiments of the present invention, a display device includes a display panel having a resolution of a regular square and a plurality of pixels, a signal processor which stores first image signals corresponding to a first image of one frame and outputs second image signals corresponding to a second image having a display type changed with respect to the first image, and a data driver which converts the second image signals to data voltages to supply to the plurality of pixels.

The display device may further include a memory storing the first image signals. The signal processor may vary an output start position and an output progress direction of the first image signals stored into the memory based on a display control signal to generate the second image signals. The second image may include a display type which is changed in position with respect to at least one reference axis based on the first image. The reference axis may be an x-axis, a y-axis, a y=x axis, or combinations thereof.

The display device may further include a register storing the display control signal.

The memory may be a display data random access memory (“DDRAM”) and may include a storing region at least as large as the resolution of the display panel.

According to other exemplary embodiments of the present invention, a driving method of a display device having a resolution of a regular square includes storing image signals of one frame, defining a display type of a first image corresponding to the image signals, changing an order of the image signals based on a defined display type and outputting the changed image signals, and displaying a second image based on the changed image signals.

Defining the display type of the first image may include defining at least one reference axis for symmetry-changing the first image.

Defining the display type of the first image may include symmetry-changing the first image by defining at least one of an x-axis, a y-axis, a y=x axis, and combinations thereof as the at least one reference axis.

Defining the display type of the first image may include defining an output start position and an output progress direction of the image signals of the one frame according to a defined reference axis.

Storing the image signals of the one frame may include receiving the image signals of the one frame in order to represent the first image.

According to still other exemplary embodiments of the present invention, a display device includes a display panel having a plurality of pixels, a signal processor which stores first image signals corresponding to a first image of one frame, the first image having a first display type, and outputs second image signals corresponding to a second image of the one frame, the second image having a second display type, the second display type changeable with respect to the first display type based on a display control signal received by the signal processor, and a data driver which converts the second image signals to data voltages to supply to the plurality of pixels.

The display device may further include a memory storing the first image signals, the memory disposed within the signal processor. The signal processor may vary an output start position and an output progress direction of the first image signals stored into the memory based on the display control signal to generate the second image signals.

The display device may further include a signal controller controlling the data driver, the signal processor formed within the signal controller.

### BRIEF DESCRIPTION OF THE DRAWINGS

Exemplary embodiments of the present invention will now be described in detail with reference to the accompanying drawings for a clear understanding of aspects, features, and advantages of the present invention, wherein:

FIG. 1 is a block diagram of an exemplary liquid crystal display (“LCD”) according to the present invention;

FIG. 2 is an equivalent circuit diagram of an exemplary pixel of an exemplary LCD according the present invention;

FIG. 3 is a block diagram of an exemplary signal processor shown in FIG. 1;

FIG. 4 is a flow chart of an exemplary operation of an exemplary LCD including the signal processor shown in FIG. 3; and

FIG. 5 illustrates images including various display types with respect to an original image according to an exemplary embodiment of the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The present invention will be described more fully hereinafter with reference to the accompanying drawings, in which exemplary embodiments of the invention are shown.

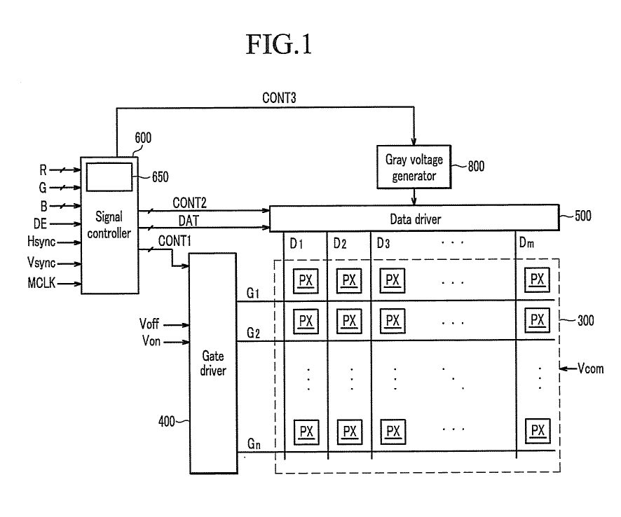

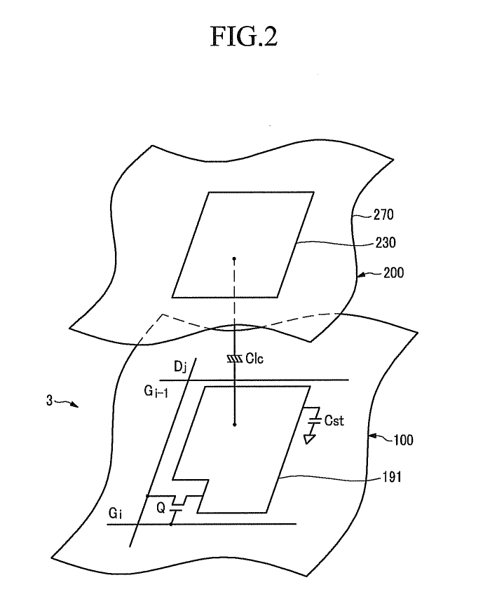

A liquid crystal display (“LCD”) according to an exemplary embodiment of the present invention will now be described in detail with reference to FIGS. 1 and 2.

FIG. 1 is a block diagram of an exemplary LCD according to the present invention, and FIG. 2 is an equivalent circuit diagram of an exemplary pixel of an exemplary LCD according to the present invention.

Referring to FIG. 1, an exemplary LCD according to the present invention includes a liquid crystal (“LC”) panel assembly 300, a gate driver 400 and a data driver 500 that are coupled with the panel assembly 300, a gray voltage generator 800 coupled with the data driver 500, and a signal controller 600 which controls the above-mentioned elements.

The panel assembly 300 includes a plurality of pixels PX connected to the signal lines G₁-Gₙ and D₁-Dₘ and arranged substantially in a matrix. In the structural view shown in FIG. 2, the panel assembly 300 includes lower and upper panels 100 and 200, respectively, facing each other and an LC layer 3 interposed between the lower and upper panels 100 and 200, respectively.

The signal lines include a plurality of gate lines G₁-Gₙ transmitting gate signals (also referred to as “scanning signals” hereinafter) and a plurality of data lines D₁-Dₘ transmitting data voltages. The gate lines G₁-Gₙ extend substantially in a first direction, such as a row direction, and substantially parallel to each other, while the data lines D₁-Dₘ extend substantially in a second direction, such as a column direction, and substantially parallel to each other. The first direction may be substantially perpendicular to the second direction.

Referring to FIG. 2, each pixel PX, for example a pixel PX connected to the i-th gate line Gᵢ (i=1, 2, . . . , n) and the j-th data line Dⱼ (j=1, 2, . . . , m), includes a switching element Q connected to the signal lines Gᵢ and Dⱼ, and an LC capacitor Clc and a storage capacitor Cst that are connected to the switching element Q. In an exemplary embodiment, the storage capacitor Cst may be omitted.

The switching element Q is disposed on the lower panel 100 and includes three terminals, i.e., a control terminal, such as a gate electrode, connected to the gate line Gᵢ, an input terminal, such as a source electrode, connected to the data line Dⱼ, and an output terminal, such as a drain electrode, connected to the LC capacitor Clc and the storage capacitor Cst.

In exemplary embodiments, the switching element Q may be a thin film transistor (“TFT”), and the TFT may include polysilicon or amorphous silicon (“a-Si”).

The LC capacitor Clc includes a pixel electrode 191, as a first terminal, disposed on the lower panel 100 and a common electrode 270, as a second terminal, disposed on the upper panel 200. The LC layer 3 disposed between the pixel electrode 191 and the common electrode 270 functions as a dielectric of the LC capacitor Clc. The pixel electrode 191 is connected to the switching element Q, and the common electrode 270 is supplied with a common voltage Vcom and covers an entire surface, or substantially an entire surface, of the upper panel 200. In exemplary embodiments, unlike in FIG. 2, the common electrode 270 may be provided on the lower panel 100, and at least one of the pixel and common electrodes 191 and 270, respectively, may include a shape of a bar or a stripe.

The storage capacitor Cst is an auxiliary capacitor for the LC capacitor Clc. The storage capacitor Cst includes the pixel electrode 191 and a separate signal line, which is provided on the lower panel 100, overlaps the pixel electrode 191 via an insulator, and is supplied with a predetermined voltage such as the common voltage Vcom. In alternative exemplary embodiments, the storage capacitor Cst includes the pixel electrode 191 and an adjacent gate line called a previous gate line, which overlaps the pixel electrode 191 via an insulator.

For a color display, each pixel PX uniquely represents one color of a set of colors (i.e., spatial division) or each pixel PX sequentially represents the set of colors in turn (i.e., temporal division) such that a spatial or temporal sum of the set of colors is recognized as a desired color. In an exemplary embodiment, a set of colors may include primary colors, and may include red, green, and blue. FIG. 2 illustrates an exemplary embodiment of the spatial division in which each pixel PX includes a color filter 230 representing one color of the set of colors in an area of the upper panel 200 facing the pixel electrode 191. In alternative exemplary embodiments, the color filter 230 is provided on or under the pixel electrode 191 on the lower panel 100.

In exemplary embodiments, one or more polarizers (not shown) are attached to the panel assembly 300.

The LC panel assembly 300 may include a resolution of a regular square in which a number of pixels PX arranged in a first direction, such as a row direction, and a number of pixels PX arranged in a second direction, such as a column direction, are substantially equal. In this case, a number of data lines D₁-Dₘ and a number of gate lines G₁-Gₙ are equal, that is, m is equal to n.

Referring to FIG. 1 again, the gray voltage generator 800 generates a full number of gray voltages or a limited number of gray voltages (referred to as “reference gray voltages” hereinafter) related to the transmittance of the pixels PX. Some of the reference gray voltages include a positive polarity relative to the common voltage Vcom, while other reference gray voltages include a negative polarity relative to the common voltage Vcom. In exemplary embodiments, a number of total gray voltages with the negative polarity or the positive polarity may be the same as a number of grays represented by the LCD.

The gate driver 400 is connected to the gate lines G₁-Gₙ of the panel assembly 300, and synthesizes a gate-on voltage Von and a gate-off voltage Voff to generate the gate signals for application to the gate lines G₁-Gₙ.

The data driver 500 is connected to the data lines D₁-Dₘ of the panel assembly 300 and applies data voltages, which are selected from the gray voltages supplied from the gray voltage generator 800, to the data lines D₁-Dₘ. However, when the gray voltage generator 800 generates only a few of the reference gray voltages rather than all the gray voltages, the data driver 500 may divide the reference gray voltages to generate the data voltages from among the reference gray voltages. The signal controller 600 controls the gate driver 400 and the data driver 500, etc. The signal controller 600 includes a signal processor 650. The signal processor 650 receives input image signals R, G, and B and stores them to generate output image signals DAT based on a control signal.

The signal processor 650 will be described in more detail below.

In exemplary embodiments, at least one of driving devices 400, 500, 600, and 800 may be integrated into the panel assembly 300 along with the signal lines G₁-Gₙ and D₁-Dₘ and the switching elements Q. In alternative exemplary embodiments, each of driving devices 400, 500, 600, and 800 may include at least one integrated circuit (“IC”) chip mounted on the LC panel assembly 300 or on a flexible printed circuit (“FPC”) film in a tape carrier package (“TCP”) type, which are attached to the panel assembly 300. In further alternative exemplary embodiments, all of the driving devices 400, 500, 600, and 800 may be integrated into a single IC chip, but at least one of the driving devices 400, 500, 600, and 800 or at least one circuit element in at least one of the driving devices 400, 500, 600, and 800 may be disposed outside of the single IC chip.

Now, the operation of the above-described exemplary LCD will be described in more detail.

The signal controller 600 is supplied with input image signals R, G, and B and input control signals for controlling the display thereof from an external graphics controller (not shown). The input image signals R, G, and B contain luminance information of pixels PX, and the luminance includes a predetermined number of grays, for example 1024 (=2¹⁰), 256 (=2⁸), or 64 (=2⁶) grays. The input control signals include a vertical synchronization signal Vsync, a horizontal synchronization signal Hsync, a main clock signal MCLK, and a data enable signal DE.

On the basis of the input control signals and the input image signals R, G, and B, the signal controller 600 generates gate control signals CONT1 and data control signals CONT2, and the signal controller 600 processes the image signals R, G, and B to be suitable for the operation of the panel assembly 300 and the data driver 500. The signal controller 600 sends the gate control signals CONT1 to the gate driver 400 and sends the processed image signals DAT and the data control signals CONT2 to the data driver 500.

The gate control signals CONT1 include a scanning start signal STV which instructs to start scanning and at least one clock signal which controls an output period of the gate-on voltage Von. In exemplary embodiments, the gate control signals CONT1 may include an output enable signal OE for defining a duration of the gate-on voltage Von.

The data control signals CONT2 include a horizontal synchronization start signal STH which informs a start of data transmission for a row of pixels PX, a load signal LOAD which instructs to apply the data voltages to the data lines D₁-Dₘ, and a data clock signal HCLK. In exemplary embodiments, the data control signal CONT2 may further include an inversion signal RVS for reversing the polarity of the data voltages (relative to the common voltage Vcom).

Responsive to the data control signals CONT2 from the signal controller 600, the data driver 500 receives a packet of the digital image signals DAT for the row of pixels PX from the signal controller 600, converts the digital image signals DAT into analog data voltages selected from the gray voltages, and then applies the analog data voltages to the data lines D₁-Dₘ.

Referring now to FIGS. 1 and 2, the gate driver 400 applies the gate-on voltage Von to a gate line G₁-Gₙ in response to the gate control signals CONT1 from the signal controller 600, to thereby turn on the switching transistors Q connected thereto. The data voltages applied to the data lines D₁-Dₘ are then supplied to the pixels PX through the activated switching transistors Q.

A voltage difference between a data voltage and the common voltage Vcom applied to a pixel PX is represented as a voltage across the LC capacitor Clc of the pixel PX, which is referred to as a pixel voltage. The LC molecules in the LC capacitor Clc include orientations depending on the magnitude of the pixel voltage, and the molecular orientations determine the polarization of light passing through the LC layer 3. The polarizer(s) converts light polarization to light transmittance such that the pixel PX includes a luminance represented by a gray of the data voltage.

By repeating this procedure by a unit of a horizontal period (which is also referred to as “1H” and is equal to one period of the horizontal synchronization signal Hsync and the data enable signal DE), all gate lines G₁-Gₙ are sequentially supplied with the gate-on voltage Von, thereby applying the data voltages to all pixels PX in order to display an image for a frame.

When the next frame starts after one frame finishes, the inversion signal RVS applied to the data driver 500 is controlled such that the polarity of the data voltages is reversed (which is referred to as “frame inversion”). In exemplary embodiments, the inversion signal RVS may be controlled such that the polarity of the data voltages flowing in a data line are periodically reversed during one frame (for example, row inversion and dot inversion), or in alternative exemplary embodiments, the polarity of the data voltages in one packet are reversed (for example, column inversion and dot inversion).

Meanwhile, in the current exemplary embodiment, when the LCD includes a resolution of the regular square, a display type of an image may be changed by a user.

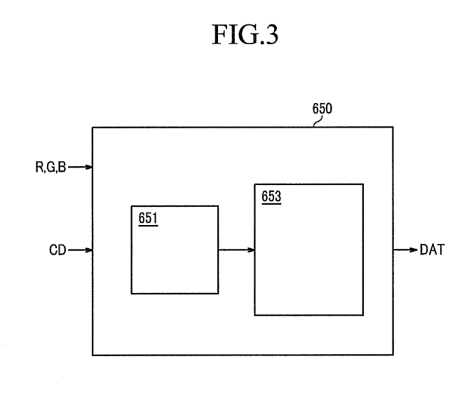

Hereinafter, referring to FIGS. 3 to 5, an operation of the signal processor 650 which varies a display type of an image and an image processing operation of the LCD will be described.

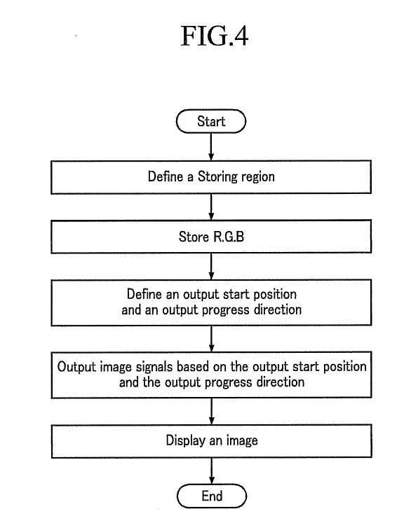

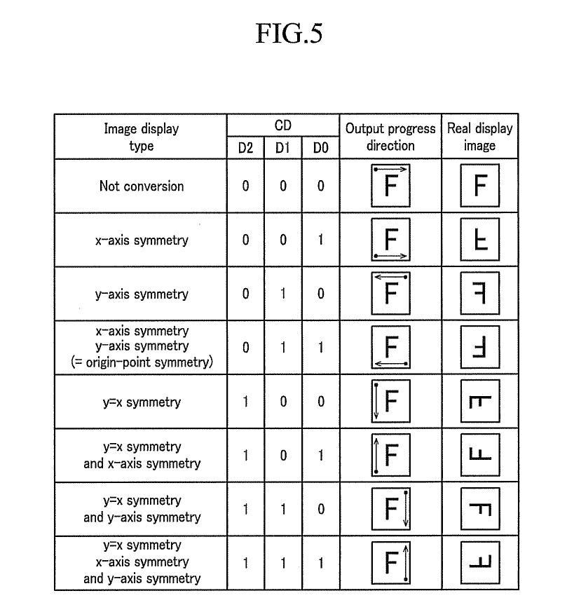

FIG. 3 is a block diagram of an exemplary signal processor 650 shown in FIG. 1, FIG. 4 is a flow chart of an exemplary operation of an exemplary LCD including the exemplary signal processor 650 shown in FIG. 3, and FIG. 5 illustrates images including various display types with respect to an original image according to an exemplary embodiment of the present invention.

Referring to FIG. 3, the signal processor 650 includes a register 651 and a memory 653.

The register 651 receives and stores a display control signal CD indicating a display type of an image (hereinafter, referred to as “an original image”) which is displayed by the input image signals R, G, and B and control signals (not shown), which control operations of the memory 653.

The display control signal CD indicates an output start position (that is, an output start address) and an output progress direction corresponding to the display type selected by the user.

In exemplary embodiments, the memory 653 may be a display data random access memory (“DDRAM”), although other types of random access memory are within the scope of these embodiments. The memory 653 receives the input image signals R, G, and B of one frame unit as bit units, and stores the input image signals R, G, and B into predetermined addresses by bit unit, respectively. In exemplary embodiments, the memory 653 may include a storing region that is equal to a resolution of the LC panel assembly 300, however, in alternative exemplary embodiments, the memory 653 may include a storing region that is larger than the resolution of the LC panel assembly 300.

The signal processor 650 reads the input image signals R, G, and B stored in the memory 653 based on the position and direction defined according to the display control signal CD, and processes the read image signals R, G, and B to generate output image signals DAT.

Referring to FIG. 4, an exemplary operation of the signal processor 650 will now be described in more detail.

The signal processor 650 receives information about a size of a storing region of the memory 653 and a start address of the memory 653 for writing the input image signals R, G, and B. At this time, when the memory 653 stores the input image signals R, G, and B of an amount larger than the resolution of the LC panel assembly 300, the signal processor 650 defines a storing region for the input image signals R, G, and B with respect to the LC panel assembly 300 of the total storing region of the memory 653. In an exemplary embodiment, the information such as the storing regions may be stored in the register 651, however, in alternative exemplary embodiments, the information such as the storing regions may be stored in a separate register (not shown).

Next, the signal processor 650 receives the input image signals R, G, and B from an external graphics controller (not shown).

When a control signal (not shown) instructing to write the input image signals R, G, and B is inputted, the signal processor 650 starts to write the input image signals R, G, and B into the memory 653, and thereby the input image signals R, G, and B of one frame are stored into predetermined addresses of the defined region, respectively.

After storing the input image signals R, G, and B of one frame, the display control signal CD is input from an external device to be stored into the register 651. The register 651 outputs data corresponding to a value of the display control signal CD to the signal processor 650. The value of the display control signal CD is defined by a user based on a desired display type of the original image. That is, by varying the value of the display control signal CD, the user can obtain a left-right reversed image (a mirror image), or a top-bottom reversed image, etc., with respect to the original image.

As shown in FIG. 5, the display control signal CD includes a digital signal of three bits D2, D1, and D0. In the current exemplary embodiment, the number of display types obtained by varying the value of the display control signal CD may be equal to eight (=2³). In exemplary embodiments, the number of bits of the display control signal CD may be changed based on the number of desired display types. That is, as shown in FIG. 5, the eight display types are of an original image (not changed), an x-axis symmetry, a y-axis symmetry, an x-axis and y-axis symmetry (origin-point symmetry), a y=x symmetry, a y=x symmetry and a y-axis symmetry, a y=x symmetry and a x-axis symmetry, and a y=x symmetry and the origin-point symmetry.

The signal processor 650 reads the input image signals R, G, and B from the memory 653 from an output start position and in an output progress direction to output image data signals DAT. The output start position and the output progress direction are defined by the data that varies according to the value of the display control signal CD. At this time, except for a case in which the original image is output without a display type-transformation, a read order of the input image signals R, G, and B is different from a write order of the image signals R, G and B.

In an exemplary embodiment, when a value of the display control signal CD is “011”, the signal processor 650 outputs the input image signals R, G, and B from the memory 653 to display an image including the origin-point symmetry with respect to the original image.

Thus, the signal processor 650 defines an output (read) start position as a pixel PX of the bottom and most right position and the output progress direction as from the right to the left, with reference to FIG. 1. Thereby, the signal processor 650 sequentially reads from the input image signal R, G, and B corresponding to the pixel PX and the corresponding output progress direction.

Therefore, a read operation of the input image signals R, G, and B is performed in an opposite direction to a write operation, and the signal processor 650 processes the read image signals R, G, and B to output to the data driver 500 as the output image signals DAT.

The data driver 500 receives the output image signals DAT sequentially supplied by row unit, converts the output image signals DAT to analog data voltages, and supplies the analog data voltages from the first pixel row to the last pixel row.

Since a data voltage corresponding to the most right of the original image is supplied to a pixel PX arranged in the first row and in the first column, an image of the original-point symmetry with respect to the original image is displayed in the LC panel assembly 300.

When an image is displayed that includes a different display type from the original image in the next frame, the signal processor 650 receives one display control signal CD without reception of separate input image signals R, G, and B from the external device.

Thereby, the signal processor 650 varies the output start position and the output progress direction of the input image signals R, G, and B stored in the memory 653 based on the display control signal CD, to thereby display an image of a changed display type with respect to the original image in the next frame. That is, the signal processor 650 changes output order of the input image signals R, G, and B based on the display control signal CD.

According to exemplary embodiments of the present invention, an image of various display types with respect to an original image is displayed based on a display control signal.

In addition, since input image signals of one frame are stored, an image of a desired display type is displayed by receiving only a display control signal before input image signals are changed, and thereby signal processing time decreases.

While this invention has been described in connection with what is presently considered to be some exemplary embodiments, it is to be understood by those of ordinary skill in the art that the invention is not limited to the disclosed exemplary embodiments, but, on the contrary, is intended to cover various modifications, changes in form and details, and equivalent arrangements included within the spirit and scope of the appended claims.

What is claimed is:

1. A display device comprising:
a display panel having a resolution of a regular square and a plurality of pixels;
a signal processor which stores first image signals corresponding to a first image of one frame and outputs second image signals corresponding to a second image having a display type changed with respect to the first image; and
a data driver which converts the second image signals to data voltages to supply to the plurality of pixels.

2. The display device of claim 1, further comprising a memory storing the first image signals.

3. The display device of claim 2, wherein the signal processor varies an output start position and an output progress direction of the first image signals stored into the memory based on a display control signal to generate the second image signals.

4. The display device of claim 3, wherein a number of different display types of the display device is equal to 2×, where x is a number of bits of the display control signal.

5. The display device of claim 3, wherein the second image includes a display type which is changed in position with respect to at least one reference axis based on the first image.

6. The display device of claim 5, wherein the reference axis is one of an x-axis, a y-axis, a y=x axis, and combinations thereof.

7. The display device of claim 3, further comprising a register storing the display control signal.

8. The display device of claim 2, wherein the memory is a display data random access memory.

9. The display device of claim 2, wherein the memory includes a storing region at least as large as the resolution of the display panel.

10. A driving method of a display device having a resolution of a regular square, the method comprising:
storing image signals of one frame;
defining a display type of a first image corresponding to the image signals;
changing an order of the image signals based on a defined display type and outputting changed image signals; and
displaying a second image based on the changed image signals.

11. The driving method of claim 10, wherein defining the display type of the first image comprises defining at least one reference axis for symmetry-changing the first image.

12. The driving method of claim 11, wherein defining the display type of the first image comprises symmetry-changing the first image by defining at least one of an x-axis, a y-axis, a y=x axis, and combinations thereof as the at least one reference axis.

13. The driving method of claim 12, wherein defining the display type of the first image defines an output start position and an output progress direction of the image signals of the one frame according to a defined reference axis.

14. The driving method of claim 13, wherein storing the image signals of the one frame includes receiving the image signals of the one frame in order to represent the first image.

15. The driving method of claim 10, wherein storing the image signals of one frame includes storing the image signals of one frame within a memory of a signal processor, the signal processor disposed within a signal controller of the display device.

16. A display device comprising:
a display panel having a plurality of pixels;
a signal processor which stores first image signals corresponding to a first image of one frame, the first image having a first display type, and outputs second image signals corresponding to a second image of the one frame, the second image having a second display type, the second display type changeable with respect to the first display type based on a display control signal received by the signal processor; and
a data driver which converts the second image signals to data voltages to supply to the plurality of pixels.

17. The display device of claim 16, further comprising a memory storing the first image signals, the memory disposed within the signal processor.

18. The display device of claim 17, wherein the signal processor varies an output start position and an output progress direction of the first image signals stored into the memory based on the display control signal to generate the second image signals.

19. The display device of claim 17, further comprising a signal controller controlling the data driver, the signal processor formed within the signal controller.

20. The display device of claim 16, wherein the display panel has a resolution of a regular square.
